(19) United States
(12) Patent Application Publication
(10) Pub. No.: US 2010/0079870 A1
(43) Pub. Date: Apr. 1, 2010

(54) GLARE REDUCTION FILM FOR DISPLAY SCREENS

(75) Inventor: Jiangrong Cao, Tucson, AZ (US)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/239,693

(22) Filed: Sep. 26, 2008

(51) Int. Cl. G02B 27/00; B05D 5/06

(52) U.S. Cl. 359/614; 427/164; 359/601

(57) ABSTRACT

The present disclosure is directed to a film for reducing reflections of ambient light on a display screen while maintaining efficient transmission of light emitted from the display screen. The film has a light receiving face and a light emitting face, and includes an arrayed plurality of truncated tapered structures projecting from the light receiving face to the light emitting face. Each of the plurality of truncated tapered structures has a relatively wider base positioned at the light receiving face, and a relatively narrowed top positioned at the light emitting face. The plurality of truncated tapered structures define a void region in the vicinity of the light emitting face between adjacent ones of the plurality of truncated tapered structures. The film further includes a dark material applied in the void region.

### BACKGROUND

1. Field

The present disclosure relates to reducing glare on a display screen, and more specifically relates to the structure and use of a film which reduces glare.

2. Description of the Related Art

When a user views a display screen, such as a Liquid Crystal Display (LCD), in an ambient light condition, a well-known problem exists in which the ambient light reflects from the display creating a glare, which in turn prevents the user from clearly viewing the display screen. For example, with computer monitors, LCD camera displays, televisions and the like, when ambient light from indoor lighting or lighting through a window is strong enough such that the reflection of light on the display screen creates a glare, the glare makes it difficult for the user to view the image on the display screen.

Many known methods exist which address the problem of glare; however, the present disclosure sets forth a different solution than those known methods in order to reduce glare on display screens.

### SUMMARY OF THE INVENTION

In the present disclosure, the foregoing described problem of glare is addressed by providing a film for reducing reflections of ambient light on a display screen while maintaining efficient transmission of light emitted from the display screen. The film has a light receiving face and a light emitting face, and the film includes an arrayed plurality of truncated tapered structures projecting from the light receiving face to the light emitting face. Each of the plurality of truncated tapered structures has a relatively wider base positioned at the light receiving face, and a relatively narrowed top positioned at the light emitting face. The plurality of truncated tapered structures define a void region in the vicinity of the light emitting face between adjacent ones of the plurality of truncated tapered structures. The film further includes a dark material applied in the void region.

By virtue of the foregoing arrangement, it is ordinarily possible to guide the light emitting from the display screen using the plurality of truncated tapered structures so as to maintain a high percentage of transmission rate of the emitting light. More precisely, light emitted from the display screen and received at the light receiving face of the film is not substantially blocked or absorbed by the film, but rather enters into the relatively wider bases of the truncated tapered structures. Through internal reflections inside the truncated tapered structures, substantially all such light is in turn emitted from the light emitting face without significant loss in brightness to thereby preserve the brightness of a picture to be viewed on the display screen. In addition, by virtue of the dark material applied in the void region, a substantial percentage of ambient light received at the light emitting face is absorbed so as to not reflect from the film or from the display screen beneath the film. Thus, a substantial amount of possible glare is reduced. In this regard, since the ambient light is absorbed, rather than scattered or reflected at a wider angle, or filtered using a polarization filter, glare produced by all light is substantially reduced. In this regard, the film substantially reduces glare when the glare is produced by light coming from all angles (i.e., anywhere from 0 degree to 90 degree polar angle, and from 0 degree to 180 degree azimuth angle), when the glare is produced by all light having any polarization (i.e., any combination of s and p lights), and when the glare is produced by all light in the visible wavelength. Moreover, by absorbing the ambient light using the dark material, the dark material prevents light from entering into the internal structures of the display screen. Thus, the dark material substantially prevents a secondary glare caused by ambient light entering the internal structure of the display screen and reflecting from structures and surfaces of the display screen. In general, the transmission rate of the emitting light from the display screen is defined as the signal, and the ambient light reflecting from the display screen is defined as noise. Thus, the film provides the advantageous effect of substantially increasing the signal-to-noise ratio of the display screen.

According to one aspect of the present disclosure, the display screen includes an array of light emitting pixels, wherein the base of each truncated tapered structure is sized in close correspondence to a size of a pixel of the display screen. In this aspect, each truncated tapered structure is positioned so as to be aligned with a corresponding one of the arrayed pixels of the display screen. In addition, the film has a sufficient thickness to support a ratio of an area of the base to an area of the top of each truncated tapered structure which is larger than 1:1. For example, if the film has a thickness of at least 670 microns, then the film can support a ratio of an area of the base to an area of the top of each truncated tapered structure in a range substantially around 1:1 to 10,000:1. The foregoing arrangement provides the advantageous effect of substantially increasing the signal-to-noise ratio of the display screen as described above, while maintaining a wide viewing angle for users of the display screen. In particular, a wide viewing angle is maintained because the size of the truncated tapered structures allows light emitting from the display screen to emit from the top of each truncated tapered structure at wider angles.

In a different aspect of the present disclosure, the display screen includes an array of light emitting pixels, and the base of each truncated tapered structure is sized substantially smaller than a size of a pixel of the display screen. In addition, the film has a sufficient thickness to support a ratio of an area of the base to an area of the top of each truncated tapered structure in a range which is larger than 1:1. For example, if the film has a thickness of at least 65 microns, then the film can support a ratio of an area of the base to an area of the top of each truncated tapered structure in a range substantially around 1:1 to 10,000:1. Because the base of each truncated structure is sized substantially smaller than a size of a pixel of the display screen, an advantageous effect is obtained in that an amount of ambient light absorbed by the dark material remains the same or is increased when compared with the amount of ambient light absorbed in film with truncated tapered structures with larger bases. Furthermore, the same or increased amount of ambient light absorbed by the dark material is obtained in this arrangement, while the percentage of transmission rate is increased for light emitting from the display screen and received at the receiving face of the film. More specifically, a higher transmission rate of light emitted from the display screen is obtained because a taper angle of the truncated tapered structures can be decreased, which in turn increases the transmission rate of emitted light. This increase in transmission rate of emitted light is obtained while the same or larger ratio of an area of the base to an area of the top is maintained for each of the truncated tapered structures. Thus, the signal-to-noise ratio for the display screen is further increased in this arrangement. In addition, because each of the truncated tapered structures is sized substantially smaller than a size of a pixel of the display screen, an advantageous effect is obtained in that each of the truncated tapered structures does not need close alignment with pixels of the display screen, which makes it easier to properly apply the film to the display screen.

In yet another aspect, each of the truncated tapered structures consists of a refractive material. Because each of the truncated tapered structures consists of a refractive material (e.g., a material having a refractive index of around 1.5 to 1.7), the truncated tapered structures provide a good waveguide for the light emitting from the display screen and received at the receiving face of the film by condensing the emitting light without allowing much absorption. Thus, the truncated tapered structures provide a high percentage of transmission rate for the emitting light from the display screen.

In an additional aspect, an advantageous effect is obtained when each of the truncated tapered structures has an inner core and at least one outer shell surrounding the inner core, and the inner core has a higher refractive index than a refractive index of the outer shell. More specifically, because an inner core has a higher refractive index than an outer shell surrounding the inner core, an advantageous effect is obtained in that light emitting from the display screen and received at the light receiving face will mostly be confined in the inner core so as to reduce interaction with the dark material. Therefore, a further increase in transmission rate is obtained for the light emitting from the display screen. This arrangement is especially advantageous in a situation in which there is an interface between the truncated tapered structures and the dark material and the smoothness of the interface is difficult to guarantee or control.

In another aspect, an advantageous effect is obtained by providing a matte surface on a surface on each of the narrowed tops of each of the tapered truncated structures. In particular, because a surface on the top of each truncated tapered structure is a matte surface, an advantageous effect is obtained in that any possible glare is reduced when the glare results from ambient light reflecting on such top surfaces because the matte surface increases the angular spreading of the reflecting light. Thus, the matte surface reduces remaining possible glare forming on such top surfaces of the truncated tapered structures by reducing light reflecting back towards the user.

In yet another aspect, the dark material is applied so as to completely fill the void region. By completely filling the void region with dark material, there is a greatly reduced chance of ambient light received at the light emitting face reaching through the dark material and entering into the internal layered structure of the display screen.

In an additional aspect, the dark material is applied so as to create a layer on the surface of the plurality of truncated tapered structures in the void region. In some aspects of the disclosure, it may be enough to apply a layer of dark material only on sidewalls of the plurality of truncated tapered structures in the void region, rather than filling or substantially filling the void region. This layer may be sufficient to efficiently absorb ambient light. It further may reduce the difficulty in fabricating the film.

In another aspect, the dark material has a refractive index close to 1. In this regard, the dark material should have a real part of its refractive index close to 1, and an imaginary part of its refractive index close to zero, but not exactly zero (to ensure absorption). Accordingly, the dark material has a refractive index close to the refractive index of air, so that there is little surface reflection. Therefore, ambient light is absorbed and not reflected on the surface of the dark material.

In yet another aspect, the plurality of truncated tapered structures is arrayed so that the bases of the plurality of truncated tapered structures are close-packed on the light receiving face. Because the bases of the plurality of truncated tapered structures are close-packed on the light emitting face, an advantageous effect is obtained in that light emitting from the display screen and received at the light receiving face of the film has a higher transmission rate. More specifically, light emitting from the display screen and received at the light receiving face has a higher transmission rate in this arrangement because more emitted light is condensed into the truncated tapered structures, rather than blocked or absorbed by the dark material in the void region between the truncated tapered structures.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF DRAWINGS

FIG. 1 is a cross-sectional view of a first exemplary embodiment.

FIG. 2 is another cross-sectional view of the first exemplary embodiment.

FIG. 3 is yet another cross-sectional view of the first exemplary embodiment.

FIG. 4 is a cross-sectional view of a second exemplary embodiment.

FIG. 5 is another cross-sectional view of the second exemplary embodiment.

FIG. 6 is yet another cross-sectional view of the second exemplary embodiment.

FIG. 7 shows four different views of an isolated truncated tapered structure with dark material according to an exemplary embodiment.

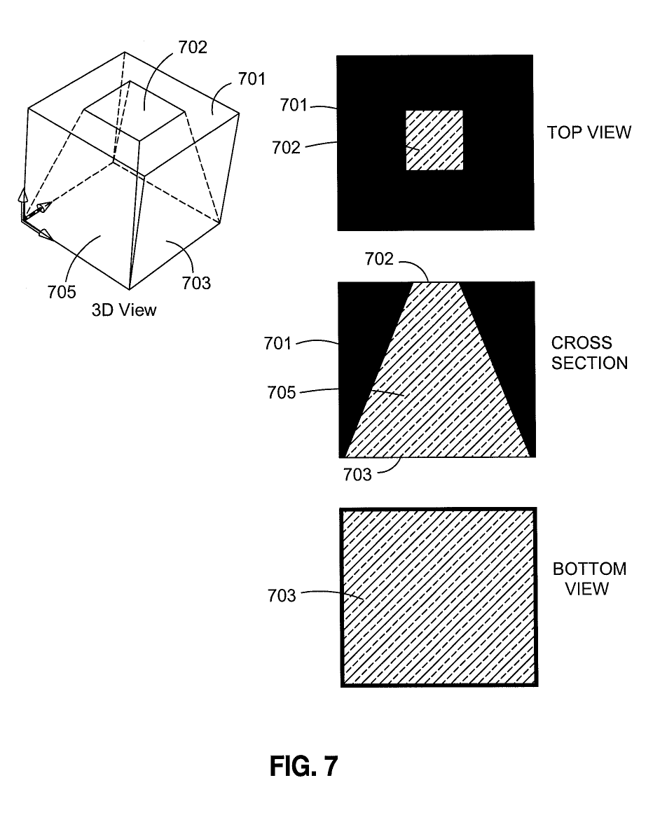

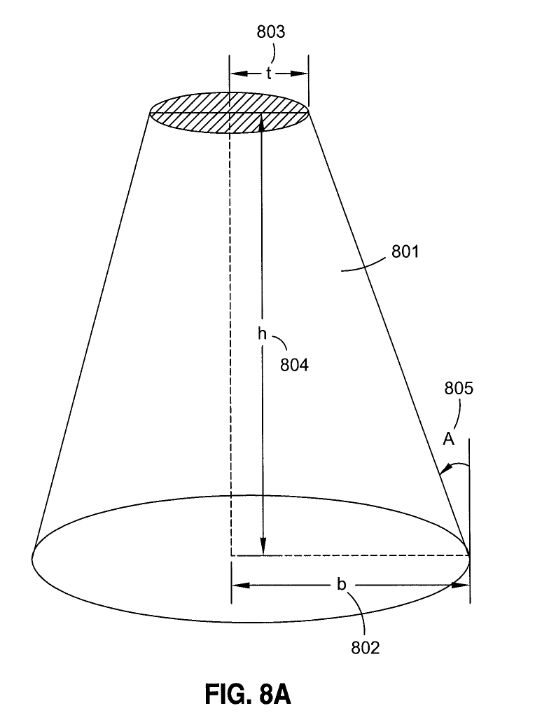

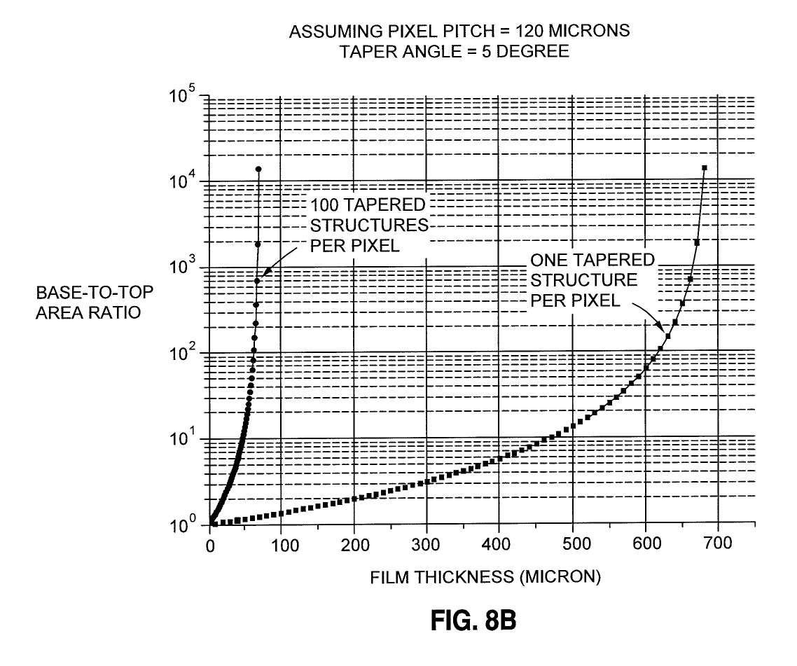

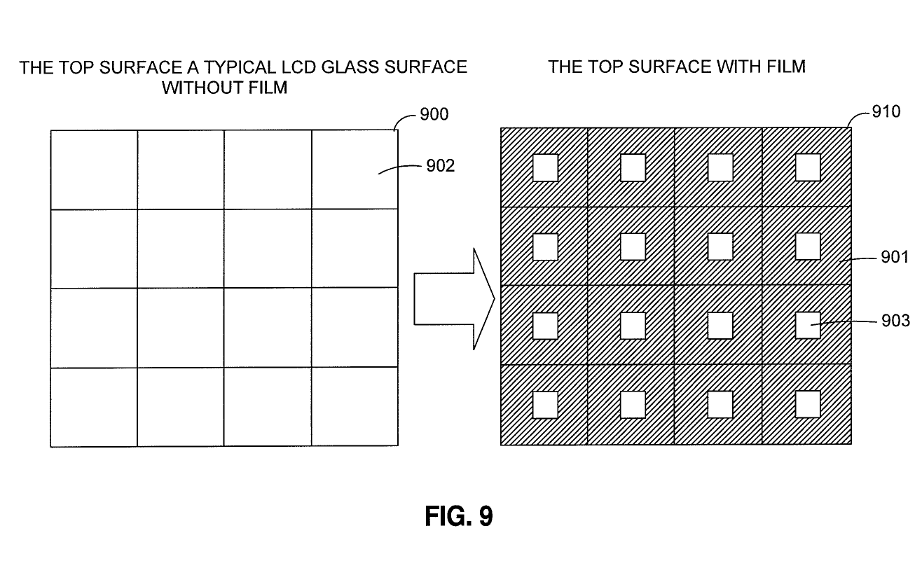

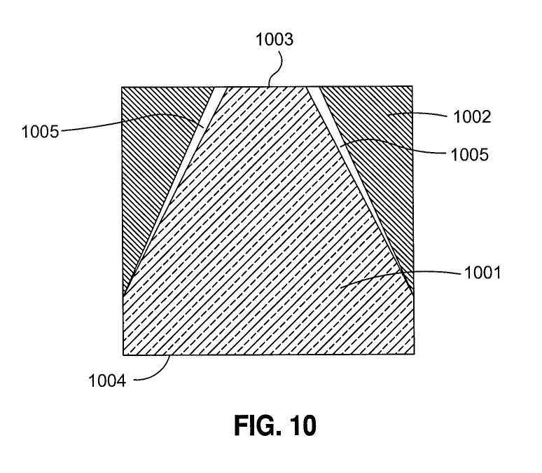

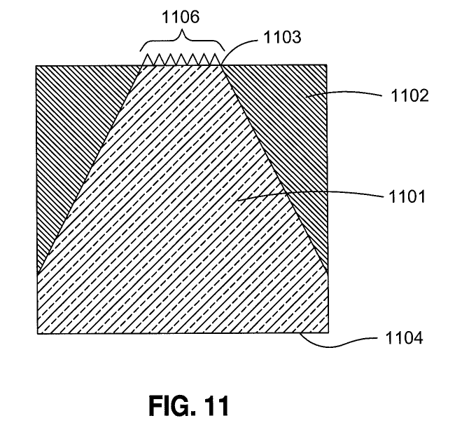

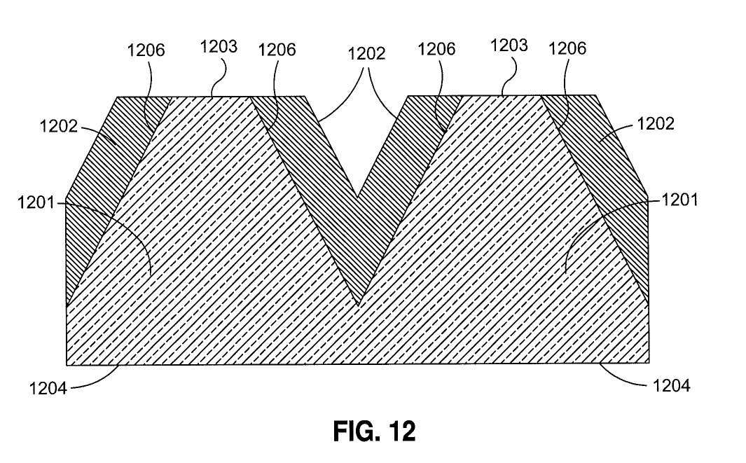

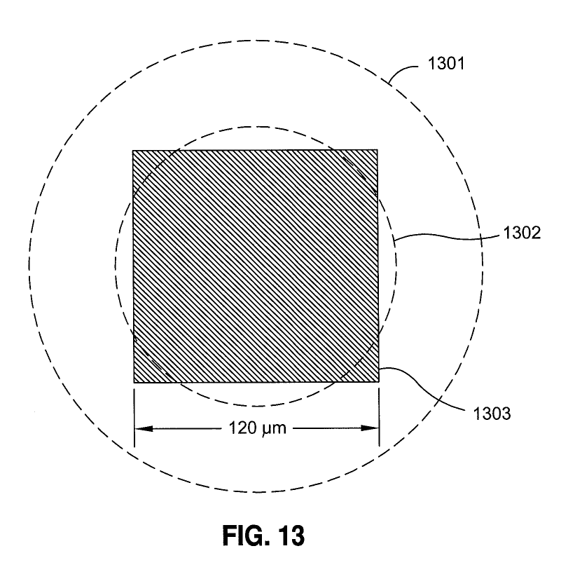

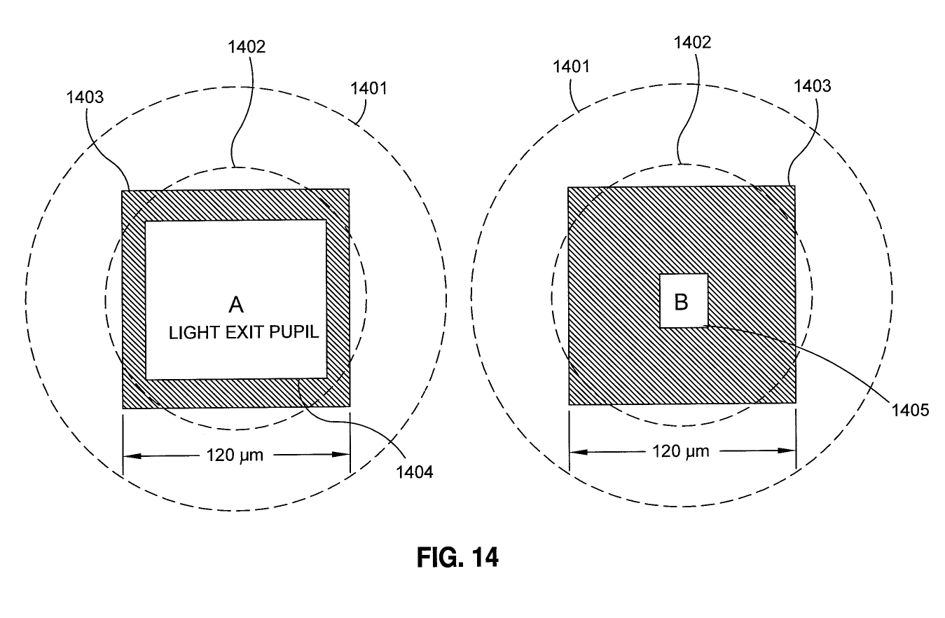

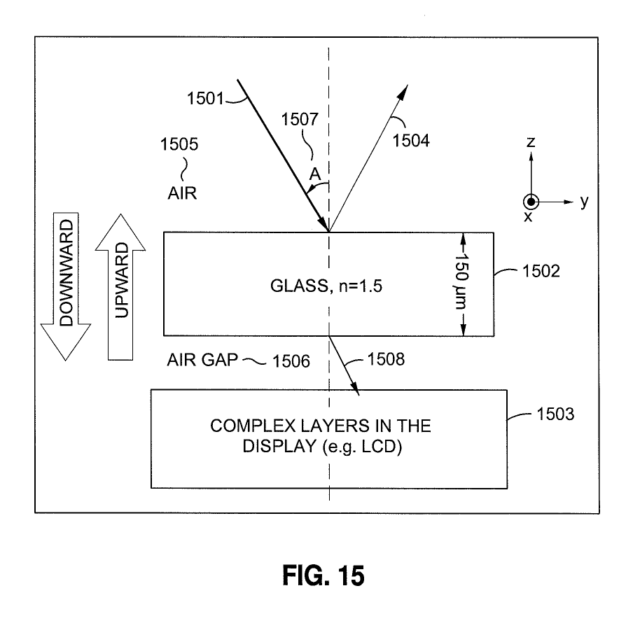

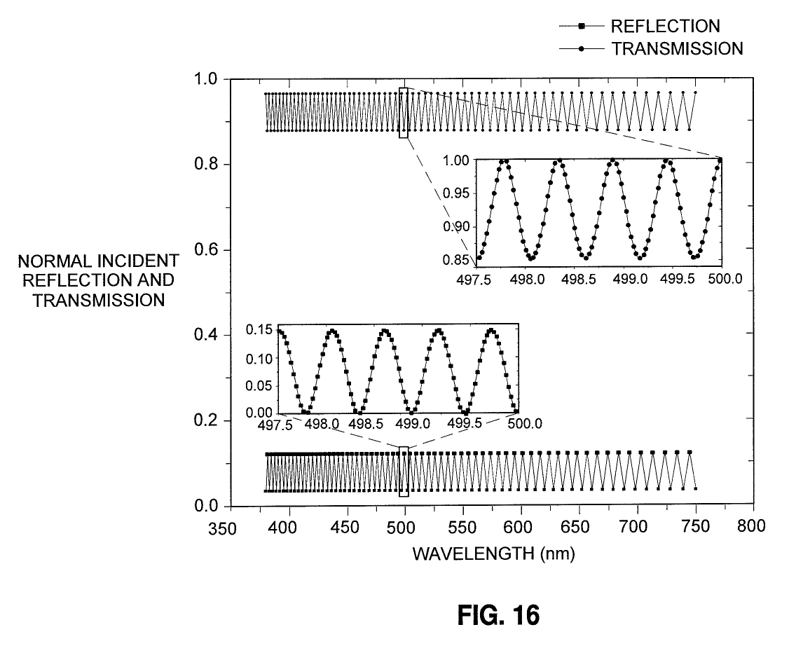

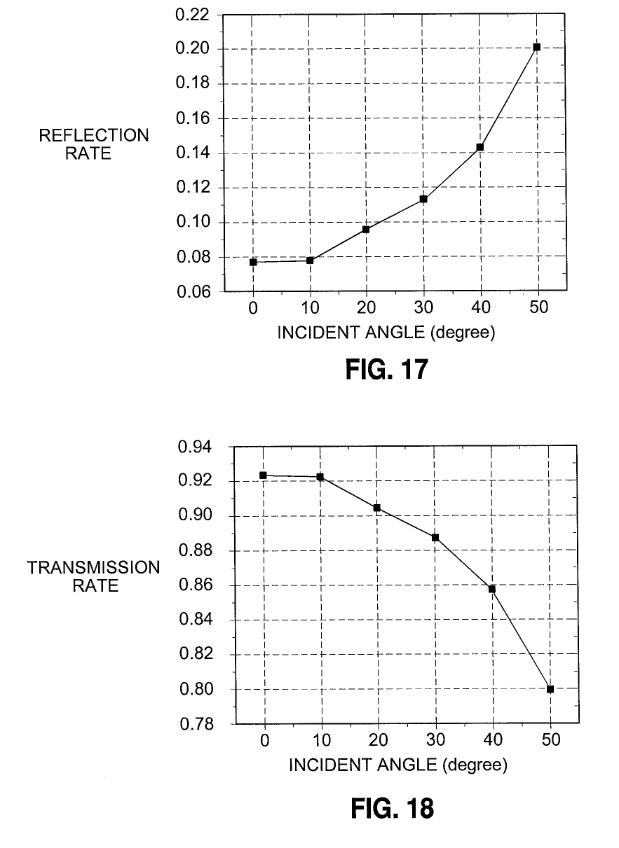

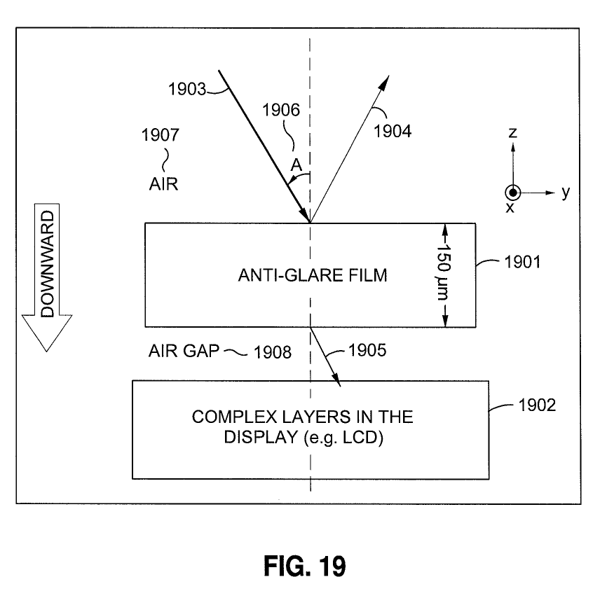

FIG. 5A is a view of an isolated truncated tapered structure according to an exemplary embodiment.

FIG. 8B shows a plot of a base-to-top area ratio for each truncated tapered structure against a film thickness.

FIG. 9 shows a display screen without anti-glare film compared with a display screen with anti-glare film according to an exemplary embodiment.

FIG. 10 is a cross-sectional view of an isolated truncated tapered structure according to a third exemplary embodiment.

FIG. 11 is a cross-sectional view of an isolated truncated tapered structure according to a fourth exemplary embodiment.

FIG. 12 is a cross-sectional view of two truncated tapered structures with dark material according to a fifth exemplary embodiment.

FIG. 13 shows a view for explaining limitations on acuity of human vision.

FIG. 14 shows a view for explaining how an exemplary embodiment utilizes limitations on acuity of human vision.

FIG. 15 shows a geometric layout of a reference case with a simple glass plate.

FIG. 16 shows reflection rates and transmission rates for the reference case shown in FIG. 15.

FIG. 17 shows a plot of reflection rate versus incident angle for the reference case shown in FIG. 15.

FIG. 18 shows a plot of transmission rate versus incident angle for the reference case shown in FIG. 15.

FIG. 19 shows a geometric layout of a test case according to an exemplary embodiment.

FIG. 20 shows a plot of reflection rate of downward light versus an incident angle for both the reference case in FIG. 13 and the test case in FIG. 19.

FIG. 21 shows the plot of FIG. 20 in a semi-logarithm scale.

FIG. 22 shows a geometric layout of a test case according to an exemplary embodiment.

FIG. 23 shows a plot of transmission rate of upwards light versus incident angle for the test case of FIG. 22.

FIG. 24 shows a plot of a ratio of the transmission rate for the test case and the transmission rate for the reference case versus upward incident angle.

FIG. 25 shows a plot of Signal-to-Noise ratio for the reference case and the test case versus ambient light source angle.

FIG. 26 shows Electromagnetic (EM) field distributions for upward incident light and downward incident light according to an exemplary embodiment.

### DETAILED DESCRIPTION

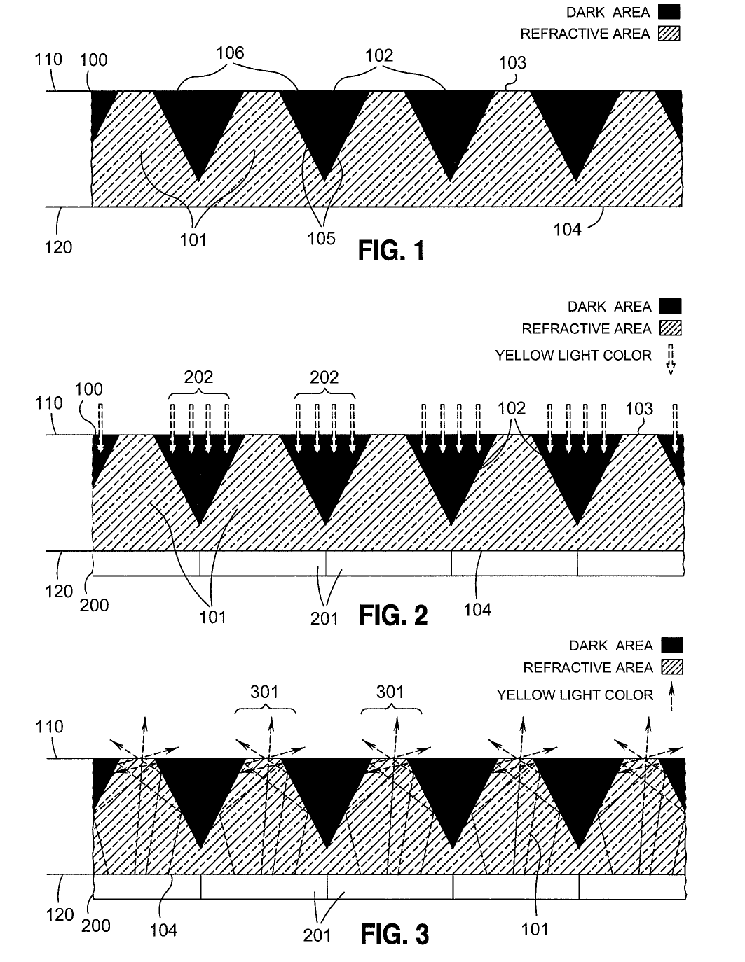

FIG. 1 is a cross-sectional view of a film according to a first example embodiment. As shown in FIG. 1, film 100 has a light emitting face 110 and a light receiving face 120. The film 100 includes truncated tapered structures 101 and dark material 102. Each of the truncated tapered structures 101 has a relatively wider base 104 positioned at the light receiving face 120, a relatively narrowed top 103 positioned at the light emitting face 110, and sidewalls 105. The truncated tapered structures 101 are positioned in an array and project from the light receiving face 120 to the light emitting face 110. The truncated tapered structures 101 are positioned so as to define a void region 106 in the vicinity of the light emitting face 110 between adjacent ones of the truncated tapered structures 101. The dark material 102 is then applied in the void region 106.

Each of the truncated tapered structures 101 has a three-dimensional shape, and more specifically has a conical shape or a pyramidal shape. Moreover, each of the truncated tapered structures 101 consists of a refractive material, and more specifically consists of a material having a refractive index in the range of 1.5 to 1.7. In addition, the truncated tapered structures 101 are positioned in an array so that the bases 104 of the truncated tapered structures are close-packed on the light receiving face 120. In this embodiment, each truncated tapered structure 101 is shown to abut next to each of the other adjacent truncated tapered structures; however, in other embodiments, it is possible for there to be space between each of the truncated tapered structures. Further in this embodiment, the sidewalls 105 do not fully extend to the light receiving face; however, in other embodiments, the sidewalls may extend closer to the light receiving face, and even fully extend to the light receiving face. It should also be noted that, although the view in FIG. 1 is a two-dimensional view, the resulting film as formed by the truncated tapered structures and dark material is a three-dimensional structure.

The dark material 102 has a refractive index close to 1. More specifically, the dark material should have a real part of its refractive index close to 1, and an imaginary part of its refractive index close to zero, but not exactly zero (to ensure absorption). Accordingly, the dark material has a refractive index close to the refractive index of air, so that there is little surface reflection. In this embodiment, the dark material 102 is applied so as to sufficiently fill the void region 106 such that the sidewalls 105 of the truncated tapered structures 101 in the void region 106 are completely covered by the dark material 102. The dark material 102 can be made up of a material such as, for example, carbon nanotubes, graphite, or nano-patterned metallic films. A discussion in greater detail on the specific properties and characteristics of example dark material can be found in the two following articles: (1) “Experimental Observation of an Extremely Dark Material Made By a Low-Density Nanotube Array” by Zu-Po Yang, et al., Nano Letters, 2008, Vol. 8, No. 2, pp. 446-451; and (2) “Omnidirectional Absorption in Nanostructured Metal Surfaces” by T. V. Teperik, et al., Nature Photonics, May 2008, Vol. 2, pp. 299-301.

FIGS. 2 and 3 will now be described to illustrate the functionality of the film 100. As shown in FIGS. 2 and 3, the film 100 is applied directly to a display screen 200 so as to fully cover the display screen 200. However, in other embodiments, the film may be applied to the display screen so that an air gap exists between the film and the display screen. The display screen 200 includes an array of light emitting pixels 201. The display screen 200 may be a display screen included on, for example, a liquid crystal display (LCD), an Organic Light Emitted Diode (OLED), a Plasma display, Rear Projections, a cathode ray tube (CRT), etc. In this embodiment, the base 104 of each truncated tapered structure 101 is sized in close correspondence to a size of a pixel 201 of the display screen 200. Further in this embodiment, each of the truncated tapered structures 101 is positioned so as to be aligned with a corresponding one of the arrayed pixels 201 of the display screen 200.

As shown in FIG. 2, ambient light is represented by the reference 202. If the film 100 was absent, the ambient light 202 would naturally reflect on the surface of the display screen 200, and in turn the reflected ambient light would create a glare. However, by virtue of the characteristics of the dark material 102 applied in the void region 106, a substantial percentage of ambient light 202 received at the light receiving face 110 is absorbed so as to not reflect from the film 100 or from the display screen 200. Thus, a substantial amount of possible glare is reduced. In this regard, since the ambient light 202 is absorbed, rather than scattered or reflected at a wider angle, or filtered using a polarization filter, glare produced by all light is substantially reduced. Accordingly, the film 100 substantially reduces glare when the glare is produced by light coming from all angles (i.e., anywhere from 0 degree to 90 degree polar angle, and from 0 degree to 180 degree azimuth angle), when the glare is produced by all light having any polarization (i.e., any combination of s and p lights), and when the glare is produced by all light in the visible wavelength. Moreover, by absorbing the ambient light 202 using the dark material 102, the dark material 102 prevents light from entering into the internal structures of the display screen 200. Thus, the dark material 102 substantially prevents a secondary glare caused by ambient light entering the internal structure of the display screen and reflecting from structures and surfaces of the display screen 200.

In FIG. 3, light emitting from the display screen 200 is represented by the reference 301. As shown in FIG. 3, the light 301 emitting from the display screen 200 enters the film 100 at the light receiving face 120, and is guided using the truncated tapered structures 101 so as to maintain a high percentage of transmission rate of the emitting light 301. More precisely, light 301 emitted from the display screen 200 and received at the light receiving face 120 of the film 100 is not substantially blocked or absorbed by the film 100, but rather enters into the relatively wider bases 104 of the truncated tapered structures 101. Through internal reflections inside the truncated tapered structures 101, substantially all of light 301 is in turn emitted from the light emitting face 110 without significant loss in brightness to thereby preserve the brightness of a picture to be viewed on the display screen 200.

In general, the transmission rate of the emitting light 301 from the display screen 200 is defined as the signal of the display screen 200, and the ambient light 202 reflecting from the display screen 200 is defined as noise. Thus, the film provides the advantageous effect of substantially increasing the signal-to-noise ratio of the display screen 200. By increasing the signal-to-noise ratio of the display screen 200, the quality of an image is substantially increased when being displayed on the display screen 200.

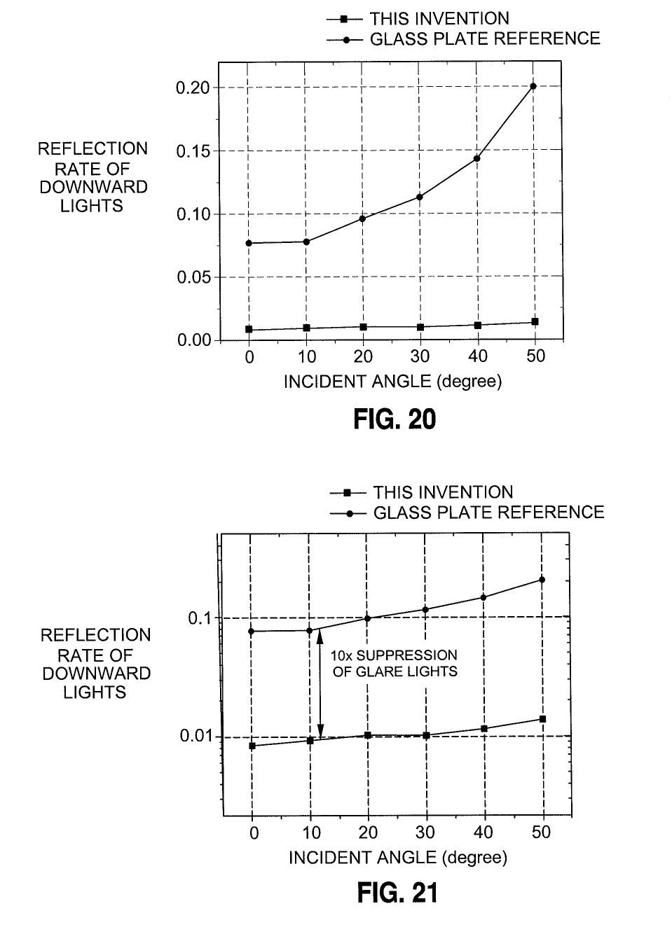

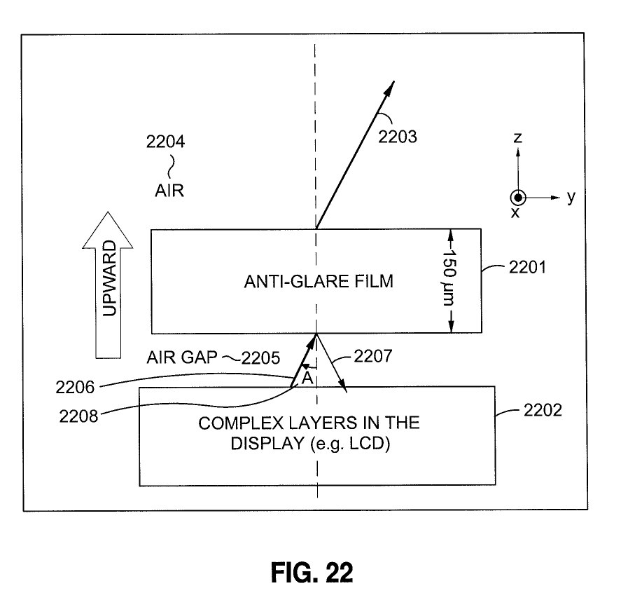

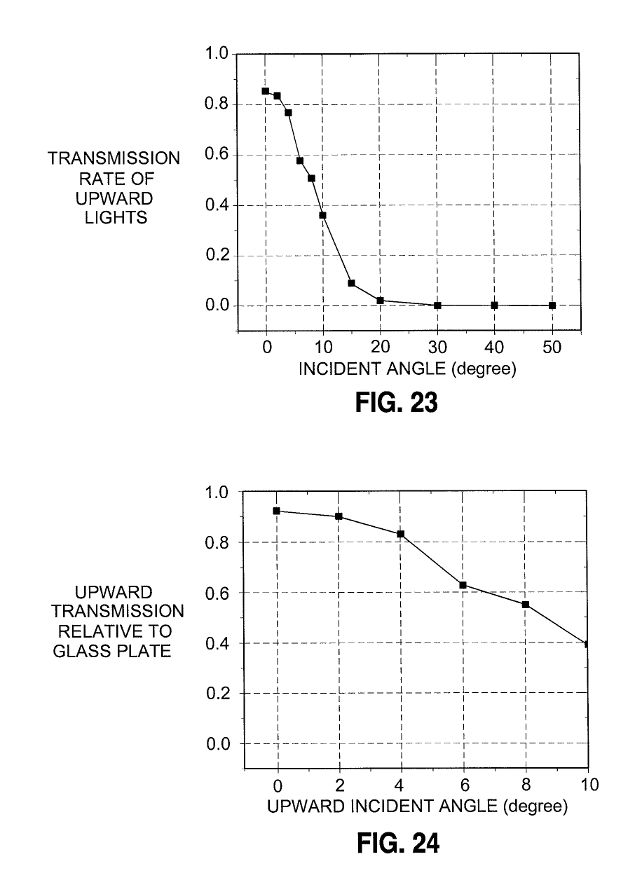

Further in this embodiment, the film 100 has a sufficient thickness to support a ratio of an area of the base 104 to an area of the top 103 of each truncated tapered structure 101 which is larger than 1:1. In particular, the ratio of an area of the base 104 to an area of the top 103 of each truncated tapered structure 101 should be at a maximum, but is limited by the thickness of the film and a taper angle of the truncated tapered structures, as described in more detail below in connection with FIGS. 6A and 6B. The foregoing arrangement provides the advantageous effect of substantially increasing the signal-to-noise ratio of the display screen 200 as discussed above, while maintaining a wide viewing angle for users of the display screen 200. In particular, a wide viewing angle is maintained because the size of the truncated tapered structures 101 allows light emitting from the display screen to emit from the top of each truncated tapered structure 101 at wider angles.

There are many different possible methods to manufacture the film in this embodiment. In particular, there are many possible methods to manufacture the array of truncated tapered structures, because the array is typically made of glass and has fairly manageable dimensions (e.g., from dozen's of microns to several hundred microns). For instance, the array of truncated tapered structures can be formed by first fusing close-packed glass cylinders between two flat glass substrates, and then by drawing the two glass substrates apart in a furnace to form the array of truncated tapered structures from the cylinder arrays. This is similar to a typical fiber drawing process, but in this instance is performed in a parallel fashion for an array of glass cylinders. In another example, the array of truncated tapered structures may also be formed by first lithographically patterning a photo resist layer with arrays of small bumps atop a flat glass substrate, where the top surfaces of the truncated tapered structures will be. Then, a highly anisotropic etching recipe (either dry etching or wet etching) is applied to form the sidewalls of the truncated tapered structures.

After the array of truncated tapered structures is formed, one can then grow the dark material in the void region defined by adjacent ones of the truncated tapered structures. For example, one can use a recipe of growing CNT (carbon nanotube) based dark material on glass substrate in water-assisted CVD (chemical vapor deposition), which is similar to the growth method reported in “Experimental Observation of an Extremely Dark Material Made By a Low-Density Nanotube Array” by Zu-Po Yang, et al., Nano Letters, 2008, Vol. 8, No. 2, pp. 446-451.

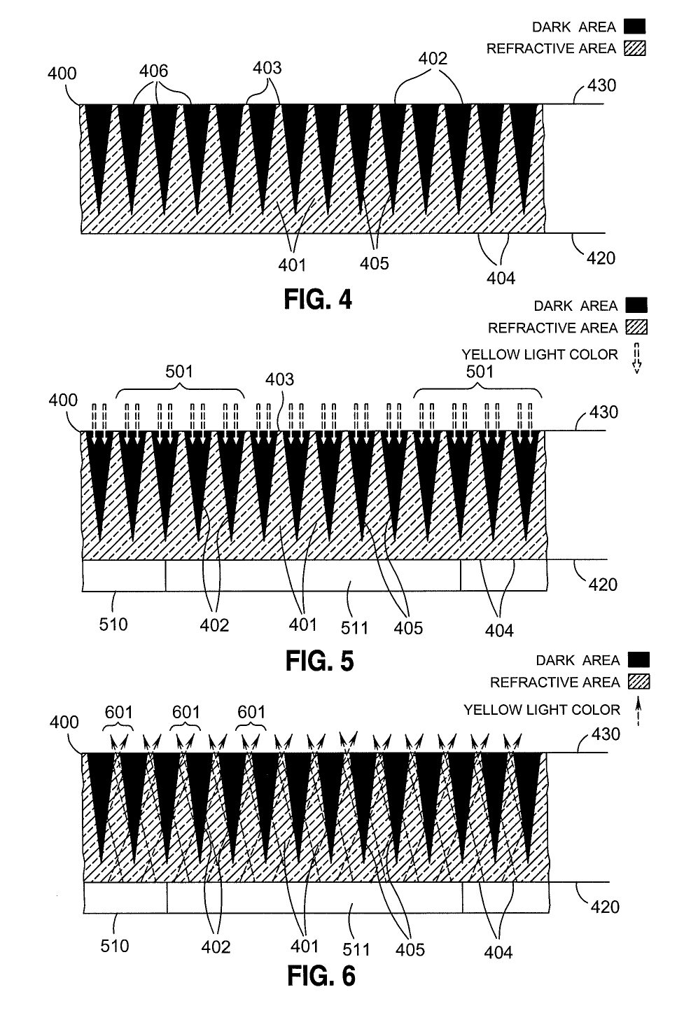

A second exemplary embodiment will now be described with reference to FIG. 4. FIG. 4 is a cross-sectional view of a film according to the second example embodiment. As shown in FIG. 4, a film 400 has a light emitting face 430 and a light receiving face 420. The film 400 includes truncated tapered structures 401 and dark material 402. Each of the truncated tapered structures 401 has a relatively wider base 404 positioned at the light receiving face 420, a relatively narrowed top 403 positioned at the light emitting face 430, and sidewalls 405. The truncated tapered structures 401 are positioned in an array and project from the light receiving face 420 to the light emitting face 430. The truncated tapered structures 401 are positioned so as to define a void region 406 in the vicinity of the light emitting face 410 between adjacent ones of the truncated tapered structures 401. The dark material 402 is then applied in the void region 406.

Each of the truncated tapered structures 401 has a three-dimensional shape, and more specifically has a conical shape or a pyramidal shape. Moreover, each of the truncated tapered structures 401 consists of a refractive material, and more specifically consists of a material having a refractive index in the range of 1.5 to 1.7. In addition, the truncated tapered structures 401 are positioned in an array so that the bases 404 of the truncated tapered structures are close-packed on the light receiving face 420. In this embodiment, each truncated tapered structure 401 is shown to abut next to each of the other adjacent truncated tapered structures; however, in other embodiments, it is possible for there to be space between each of the truncated tapered structures. Further in this embodiment, the sidewalls 405 do not fully extend to the light receiving face; however, in other embodiments, the sidewalls may extend closer to the light receiving face, and even fully extend to the light receiving face. It should also be noted that, although the view in FIG. 4 is a two-dimensional view, the resulting film as formed by the truncated tapered structures and dark material is a three-dimensional structure.

The dark material 402 has a refractive index close to 1. More specifically, the dark material 402 should have a real part of its refractive index close to 1, and an imaginary part of its refractive index close to zero, but not exactly zero (to ensure absorption). Accordingly, the dark material has a refractive index close to the refractive index of air, so that there is little surface reflection. In this embodiment, the dark material 402 is applied so as to sufficiently fill the void region 406 such that the sidewalls 405 of the truncated tapered structures 401 in the void region 406 are completely covered by the dark material 402. The dark material 402 can be made up of a material such as, for example, carbon nanotubes, graphite, or nano-patterned metallic films. A discussion in greater detail on the specific properties and characteristics of example dark material can be found in the two following articles: (1) “Experimental Observation of an Extremely Dark Material Made By a Low-Density Nanotube Array” by Zu-Po Yang, et al., Nano Letters, 2008, Vol. 8, No. 2, pp. 446-451; and (2) “Omnidirectional Absorption in Nanostructured Metal Surfaces” by T. V. Teperik, et al., Nature Photonics, May 2008, Vol. 2, pp. 299-301.

FIGS. 5 and 6 will now be described to illustrate the functionality of the film 400. As shown in FIG. 5, ambient light is represented by the reference 501. If the film 400 was absent, the ambient light 402 would naturally reflect on the surface of a display screen 510, and in turn the reflected ambient light would create a glare. However, by virtue of the characteristics of the dark material 402 applied in the void region 406, a substantial percentage of ambient light 501 received at the light receiving face 430 is absorbed so as to not reflect from the film 400 or from the display screen 510. Thus, a substantial amount of possible glare is reduced. In this regard, since the ambient light 501 is absorbed, rather than scattered or reflected at a wider angle, or filtered using a polarization filter, glare produced by all light is substantially reduced. Accordingly, the film 400 substantially reduces glare when the glare is produced by light coming from all angles (i.e., anywhere from 0 degree to 90 degree polar angle, and from 0 degree to 180 degree azimuth angle), when the glare is produced by all light having any polarization (i.e., any combination of s and p lights), and when the glare is produced by all light in the visible wavelength. Moreover, by absorbing the ambient light 501 using the dark material 402, the dark material 402 prevents light from entering into the internal structures of the display screen 510. Thus, the dark material 402 substantially prevents a secondary glare caused by ambient light entering the internal structure of the display screen and reflecting from structures and surfaces of the display screen 510.

As shown in FIG. 5, the film 400 is applied directly on the display screen 410 having an array of light emitting pixels 511. However, in other embodiments, the film may be applied to the display screen so that an air gap exists between the film and the display screen. In the second example embodiment, the base 404 of each truncated tapered structure 401 is sized substantially smaller than a size of a pixel 511 of the display screen 510. The display screen 510 may be a display screen included on, for example, a liquid crystal display (LCD), an Organic Light Emitted Diode (OLED), a Plasma display, Rear Projections, a cathode ray tube (CRT), etc. In addition, in the second example embodiment, the film 400 has a sufficient thickness to support a ratio of an area of the base 404 to an area of the top 403 of each truncated tapered structure 401 which is larger than 1:1. In particular, the ratio of an area of the base 404 to an area of the top 403 of each truncated tapered structure 401 should be at a maximum, but is limited by the thickness of the film and a taper angle of the truncated tapered structures, as described in more detail below in connection with FIGS. 6A and 6B.

In FIG. 6, light emitting from the display screen 510 is represented by the reference 601. As shown in FIG. 6, the light 601 emitting from the display screen 510 enters the film 400 at the light receiving face 420, and is guided using the truncated tapered structures 401 so as to maintain a high percentage of transmission rate of the emitting light 601. More precisely, light 601 emitted from the display screen 510 and received at the light receiving face 420 of the film 400 is not substantially blocked or absorbed by the film 400, but rather enters into the relatively wider bases 404 of the truncated tapered structures 401. Through internal reflections inside the truncated tapered structures 401, substantially all of light 601 is in turn emitted from the light emitting face 430 without significant loss in brightness to thereby preserve the brightness of a picture to be viewed on the display screen 510.

Because the base 404 of each truncated structure 401 is sized substantially smaller than a size of a pixel 511 of the display screen 510 in the second example embodiment, an advantageous effect is obtained in that an amount of ambient light absorbed by the dark material 402 remains the same or is increased when compared with the amount of ambient light absorbed in film with truncated tapered structures with larger bases. Furthermore, the same or increased amount of ambient light absorbed by the dark material 402 is obtained in this example embodiment, while the percentage of transmission rate is increased for light emitting from the display screen 510 and received at the receiving face 420 of the film. More specifically, a higher transmission rate of light emitted from the display screen 510 is obtained because a taper angle of the truncated tapered structures 401 can be decreased, which in turn increases the transmission rate of emitted light. This increase in transmission rate of emitted light is obtained while the same or larger ratio of an area of the base 404 to an area of the top 403 is maintained for each of the truncated tapered structures 401. Thus, the signal-to-noise ratio for the display screen 510 is further increased in this example embodiment. In addition, because each of the truncated tapered structures 401 is sized substantially smaller than a size of a pixel 511 of the display screen 510, an advantageous effect is obtained in that each of the truncated tapered structures 401 does not need close alignment with pixels of the display screen 510, which makes it easier to properly apply the film to the display screen 510.

There are many different possible methods to manufacture the film in this embodiment. In particular, there are many possible methods to manufacture the array of truncated tapered structures, because the array is typically made of glass and has fairly manageable dimensions (e.g., from dozen's of microns to several hundred microns). For instance, the array of truncated tapered structures can be formed by first fusing close-packed glass cylinders between two flat glass substrates, and then by drawing the two glass substrates apart in a furnace to form taper arrays from the cylinder arrays. This is similar to a typical fiber drawing process, but in this instance is performed in a parallel fashion for an array of glass cylinders. In another example, the array of truncated tapered structures may also be formed by first lithographically patterning a photo resist layer with arrays of small bumps atop a flat glass substrate, where the top surfaces of the truncated tapered structures will be. Then, a highly anisotropic etching recipe (either dry etching or wet etching) is applied to form the sidewalls of the truncated tapered structures.

After the array of truncated tapered structures is formed, one can then grow the dark material in the void region defined by adjacent ones of the truncated tapered structures. For example, one can use a recipe of growing CNT (carbon nanotube) based dark material on glass substrate in water-assisted CVD (chemical vapor deposition), which is similar to the growth method reported in “Experimental Observation of an Extremely Dark Material Made By a Low-Density Nanotube Array” by Zu-Po Yang, et al., Nano Letters, 2008, Vol. 8, No. 2, pp. 446-451.

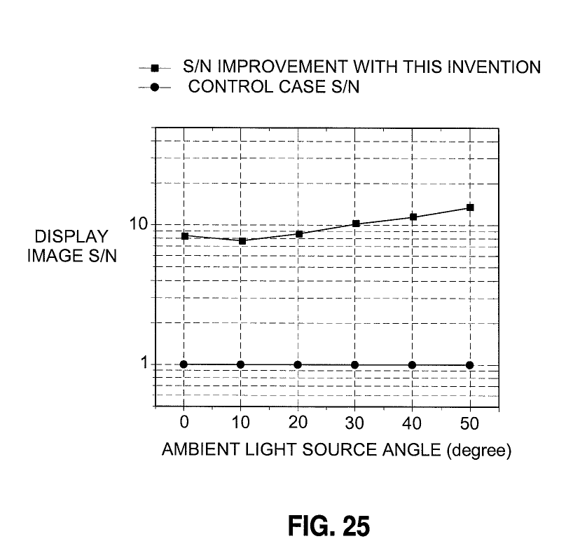

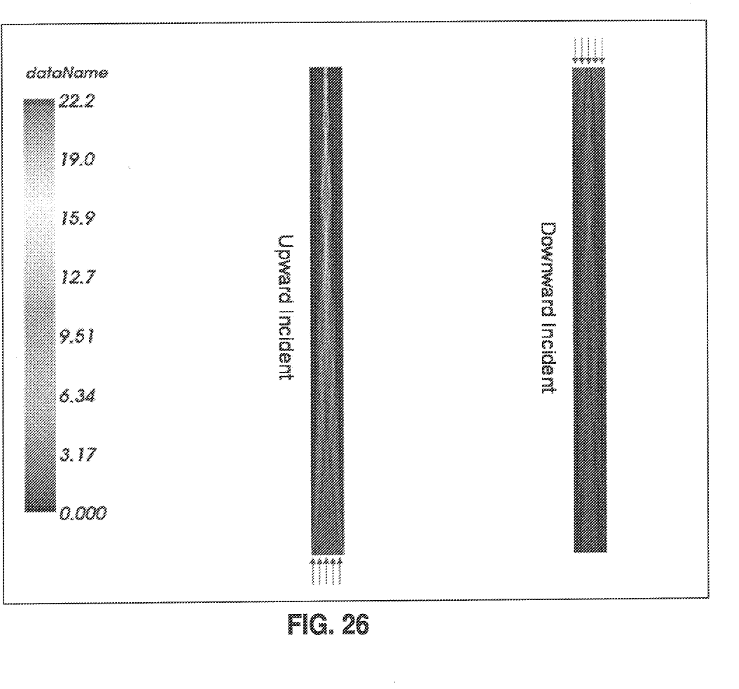

FIG. 7 shows a three-dimensional view, a top view, a cross-sectional view, and a bottom view of an isolated truncated tapered structure with dark material according to an exemplary embodiment. In FIG. 7, a bottom portion of the isolated truncated tapered structure is not shown, wherein the bottom portion not shown connects the truncated tapered structure to abutting adjacent truncated tapered structures. The isolated truncated tapered structure 705 has a wider base 703 and a more narrow top 702. The area of the base 703 should be at a maximum so as to allow a maximum amount of light emitted from a display screen to enter the truncated tapered structure 705. The truncated tapered structure then guides the emitted light towards the narrowed top 702 so as to maintain a high percentage of transmission rate for light emitted from the display screen. Furthermore, the area of the narrowed top 702 should be at a minimum so as to increase the surface area of the applied dark material 701. By increasing the surface area of the dark material 701, more ambient light is absorbed in the dark material, rather than reflected from the narrowed top 702. Thus, the area of the narrowed top 702 should be at a minimum and the area of the base 703 should be at a maximum. However, a minimum top and a maximum base for each truncated tapered structure should be balanced with a tapering angle of the truncated tapered structure so as to maintain a higher percentage of transmission rate of light emitted from the display screen, as described in more detail below in connection with FIGS. 8A and 8B.

FIG. 5A is a view of an isolated truncated tapered structure according to an exemplary embodiment. FIG. 8A will be used to describe the relationship between a ratio of the area of the base to an area of the top of a truncated tapered structure and an incident angle of the truncated tapered structure. Similar to FIG. 7, a bottom portion of the isolated truncated tapered structure is not shown in FIG. 8A, wherein the bottom portion not shown connects the truncated tapered structure to abutting adjacent truncated tapered structures. In FIG. 8A, an isolated truncated tapered structure 801 includes a base 802, a top 803, a height 804 (which mandates the thickness of the film), and a tapering angle 805. The ratio of the area of the base to an area of the top of the truncated tapered structure is defined as R_{bt}=b²/t². Moreover, the tapering angle 805 is defined as A=Tan⁻¹[(b−t)/h]. In view of these two formulas for R_{bt} and A, there is not a necessary or absolute range that R_{bt} and A must reside in. However, given a physical value for h and b, a more efficient anti-glare film can be acquired by finding a best trade-off point that both maximizes R_{bt} and minimizes A. In this regard, the larger the h/b, the easier it will be to find a better trade-off.

FIG. 8B shows a plot of a base-to-top area ratio for each truncated tapered structure against a film thickness. In FIG. 8B, it is assumed that each pixel of a display screen has a pitch of 120 microns, and that each truncated tapered structure has a tapering angle of 5 degrees. The curve on the left, labeled “100 tapered structures per pixel”, represents an example of the second exemplary embodiment, and the curve on the right, labeled “one tapered structure per pixel”, represents an example of the first exemplary embodiment. As shown in FIG. 5B, in the second exemplary embodiment, if the film has a thickness of at least 65 microns, then it's possible to obtain a base-to-top ratio of each truncated tapered structure substantially in a range from 1:1 to 10,000:1. Furthermore, in the first exemplary embodiment, if the film has a thickness of at least 670 microns, then it's possible to obtain a base-to-top ratio of each truncated tapered structure substantially in a range from 1:1 to 10,000:1. In addition, if the film has a thickness of at least 500 microns, then it's possible to obtain a base-to-top ratio of each truncated tapered structure substantially in a range from 1:1 to 20:1. As is evident from the two plots, compromises can be made as to the film thickness or to the base-to-top area ratio, in order to obtain a desired size of one or the other. In addition, the incident angle may be changed in such a manner so as to obtain an even greater base-to-top area ratio while maintaining a small thickness. Accordingly, it should be made clear that FIG. 8B is merely an example used to illustrate the possibilities of dimensions in the first and second example embodiments, and the scope of the first and second embodiments should not be limited to the dimensions used therein.

FIG. 9 shows a display screen without anti-glare film compared with a display screen with anti-glare film according to an exemplary embodiment. In FIG. 9, display screen 900 includes multiple light emitting pixels 902. Display screen 900 is a typical LCD glass surface without an application of an anti-glare film. In addition, film 910 includes dark material 901 and truncated tapered structures having narrowed tops 903. Film 910 is applied onto the display screen 900. As shown, it is clear that the display screen 900 is 100% exposed to any ambient light which could reflect from the surface and create a glare. After applying the film 910 to the display screen 900, only about 10% of the display screen 900 is exposed to ambient light. The remaining 90% is now covered by the dark material 901 which absorbs most of the ambient light, with negligible reflection.

FIG. 10 is a cross-sectional view of an isolated truncated tapered structure according to a third exemplary embodiment. The truncated tapered structure in the third exemplary embodiment may be implemented in either of the first example embodiment or second example embodiment; however, most of the details of the first and second example embodiments will be omitted for brevity. In this regard, similar to the first and second example embodiments, a dark material 1002 is applied in a void region created by adjacent ones of the truncated tapered structures. The truncated tapered structure has a relatively wider base 1004 and a relatively narrowed top 1003. As shown in FIG. 10, the truncated tapered structure has an inner core 1001 and an outer shell 1005 which surrounds the inner core 1001. Moreover, the inner core 1001 has a higher refractive index than the outer shell 1005. For example, the inner core 1001 may have a refractive index of 1.7 and the outer shell 1005 may have a refractive index of 1.5. However, the refractive index of each of the inner core 1001 and the outer shell 1005 may have different refractive indexes so long as the inner core 1001 has a higher refractive index than the outer shell 1005. Because the inner core 1001 has a higher refractive index than the outer shell 1005 surrounding the inner core, an advantageous effect is obtained in that light emitting from a display screen (not shown) and received at the light receiving face will mostly be confined in the inner core 1001 so as to reduce interaction with the dark material 1002. Therefore, a further increase in transmission rate is obtained for the light emitting from the display screen. This third example embodiment is especially advantageous in a situation in which there is an interface between the truncated tapered structures and the dark material and the smoothness of the interface is difficult to guarantee or control.

FIG. 11 is a cross-sectional view of an isolated truncated tapered structure according to a fourth exemplary embodiment. The truncated tapered structure of the fourth exemplary embodiment may be implemented in either of the first example embodiment or second example embodiment; however, most of the details of the first and second embodiments will not be discussed here for brevity. Similar to the truncated tapered structures of the first and second example embodiments, the truncated tapered structure of the fourth exemplary embodiment has a relatively wider base 1104 and a relatively narrowed top 1103. A dark material 1102 is applied in a void region created by adjacent ones of the truncated tapered structures. As shown in FIG. 11, in the fourth exemplary embodiment, the relatively narrowed top 1103 has a matte surface 1106. Because a surface on the narrowed top 1103 of the truncated tapered structure is a matte surface 1106, an advantageous effect is obtained in that any possible glare is reduced when the glare results from ambient light reflecting on such top surfaces because the matte surface increases the angular spreading of the reflecting light. Thus, the matte surface 1106 reduces remaining possible glare forming on such top surfaces of the truncated tapered structures by reducing light reflecting back towards the user. Furthermore, the matte surface 1106 may help prevent some ambient light from entering into the truncated tapered structures, and in turn help prevent some ambient light from entering into the complex layers of the display screen.

FIG. 12 is a cross-sectional view of two truncated tapered structures with dark material according to a fifth exemplary embodiment. The configuration of the fifth exemplary embodiment may be implemented in either of the first example embodiment or second example embodiment; however, most of the details of the first and second example embodiments will be omitted for brevity. Similar to each of the truncated tapered structures of the first example embodiment, in the fifth example embodiment each of the truncated tapered structures 1201 has a relatively wider base 1204 and a relatively narrowed top 1203. Further, the truncated tapered structures 1201 as part of a film are applied to a display screen (not shown). As shown in FIG. 12, a dark material 1202 is applied so as to create a layer on sidewalls 1206 of the truncated tapered structures in a void region between adjacent ones of the truncated tapered structures 1201. In this example embodiment, it may be enough to apply a layer of the dark material 1202 only on the sidewalls 1206 of the plurality of truncated tapered structures 1201 in the void region, rather than filling or substantially filling the void region. This layer of dark material 1202 may be sufficient to efficiently absorb ambient light. Another advantageous effect of only applying a layer of the dark material is that it further may reduce the difficulty in fabricating the film.

FIG. 13 shows a view for explaining limitations on acuity of human vision. In particular, the view of FIG. 13 will be used to explain how each of the exemplary embodiments takes advantage of the acuity of human vision in order to provide a film which reduces glare on a display screen, while maintaining the transmission rate of light emitting from the display screen. The resolution limit of typical human eyes is about 1 arc minute (i.e., 1/60 degrees). This means that at a viewing distance of 0.5 meters (about half an arm's length), the minimal size resolvable by the human eye is about 140 microns. Thus, anything larger than the limit represented by reference 1301 would be discernable by the average human eye. Moreover, anything smaller than the limit 1301 but larger than the limit 1302 will probably only be discernable by a human with excellent eye sight. Furthermore, anything as small as or smaller than limit 1302 is not discernable by the human eye. Thus, for example, an LCD pixel 1303 having a width of about 120 microns would not be discernable. Typical pixel sizes of display screens are smaller than what human vision can actually discern the pixels (i.e., the pixels are smaller than 140 microns). For example, the LCD viewer on a Canon Powershot SD850 IS is 2.5 inches diagonally with 230,000 pixels, with each pixel edge being about 120 microns. Thus, the human eye can not discern between the individual pixels. The exemplary embodiments utilize this limitation of human vision to provide a film for reducing glare on a display screen, while maintaining a high percentage of light emitting from the display screen as discussed in more detail below in connection with FIG. 14.

FIG. 14 shows a view for explaining how an exemplary embodiment utilizes limitations on acuity of human vision. Similar to the limits as described in FIG. 13, anything larger than the outer limits 1401 is discernable to the typical human eye. Anything smaller than the limit 1401, but larger than the limit 1402 is probably only discernable by a human with perfect vision. Lastly, anything within the limit of 1402 is not discernable by the human eye. Therefore, a human eye cannot discern between pupil 1404 and pupil 1405 because both are within the 1402 limit. For this reason, a viewer will see close to the same thing when viewing a display screen with or without a film in accordance with any of the example embodiments. More specifically, the truncated tapered structures are allowed to guide emitting light through a narrowed top while maintaining the brightness and clarity of an image on a display screen, because a human viewer cannot tell the difference so long as the same amount of lumen light is emitted. For example, if 0.1 lumen light is emitted from area 1404, so long as 0.1 lumen light is emitted from area 1405, then the human viewer will see the same thing. This is because the human viewer cannot distinguish 0.1 lumen light emitted from a 120 micron aperture and 0.1 lumen light emitted from a 35 micron aperture.

FIG. 15 shows a geometric layout of a reference case with a simple glass plate. In this reference case, transmission rates of light emitting from a complex layered display unit 1503 and reflection rates from a simple glass plate 1502 which is 150 microns thick and has a refractive index of 1.5. As shown in FIG. 15, the 150-micron thick glass plate 1502 is covering the top of the complex layered display unit 1503 (e.g., an LCD). In this reference case, it is assumed that there is an air gap 1506 between the glass plate 1502 and the complex layered display unit 1503. In addition, air 1505 is assumed to surround the outside of the glass plate 1502. The quantities computed in this reference case are transmission and reflection rates of light either going downwards (i.e., ambient light, also referred to as the source of noise), and light going upwards (i.e., light emitting from the display, also referred to as the signal). In this regard, light 1501 represents ambient light reflecting as light 1504, and then passing through the glass plate 1502 as light 1508. The light 1501 contacts the glass plate 1502 at an incident angle 1507. Lastly, in this reference case, different angles were used in computations of transmission rate and reflection rate; however, electrical polarization was limited to the x-orientation because no fundamentally different results are expected from z and y polarized lights.

FIG. 16 shows normal incident reflection and transmission rates for the reference case illustrated in FIG. 15. The transmission and reflection rates were acquired for downward light at a normal incident angle (i.e., A=0). At this point in the reference case, the effects from the complex layered display unit have not been considered. Thus, upward light flowing from the air gap through the glass plate to the air will have the same characteristics plotted in FIG. 16 for the downward light.

As shown in FIG. 16, the transmission and reflection spectra have expected Fabry-Perot oscillations across the visible spectra range. With the given glass plate thickness of 150 microns, this Fabry-Perot oscillation is very fast with its period being less than 0.5 nm. Therefore, for natural ambient lights and LCD lights, the observed transmission and reflection rates are the numerical average of such oscillation, because those lights are not coherent. After averaging, the normal incident reflection rate is 0.0777, and the transmission rate is 0.923.

Because ambient lights can come from various incident angles, transmission and reflection rates at different incident angles are also important to know. FIG. 17 shows a plot of reflection rate versus incident angle for the reference case illustrated in FIG. 15. FIG. 18 shows a plot of transmission rate versus incident angle for the reference case illustrated in FIG. 15. The plots shown in FIGS. 17 and 18 are for incident angles increasing from 0 degrees (i.e., normal incident) to 50 degrees. Furthermore, all the transmission rate and reflection rate numbers referenced are wavelength averaged values.

FIG. 19 shows a geometric layout of a test case according to an exemplary embodiment. In this test case, the truncated tapered structure being analyzed has a base of 10 micron, a height of 150 micron, and a top width of 1 micron. Further in this case study, the simulation is simplified and the truncated tapered structure is analyzed in two-dimensional space (y-z). In this regard, the truncated tapered structure is assumed to be invariant along the x-orientation. Therefore, in this simulation, a ratio of the area of the base to the area of the top of the truncated tapered structure is the same as a base-to-top linear ratio. In real devices, the truncated tapered structure is obviously three-dimensional. Thus, in real three-dimensional cases, the ratio of the area of the base to the area of the top of the truncated tapered structure will be the square of the base-to-top linear ratio. For example, if a base-to-top linear ratio is 10:1, then the three-dimensional ratio of the area of the base to the area of the top will be 100:1. Accordingly, the real three-dimensional film will further reduce the reflection of ambient lights then the results obtained by this simulation. Lastly, in this simulation, the truncated tapered structures are assumed to have a refractive index of 1.5, and the dark material is assumed to have a refractive index of n=1.026+i0.0048, which is extracted from experimental data reported in “Experimental Observation of an Extremely Dark Material Made By a Low-Density Nanotube Array” by Zu-Po Yang, et al., Nano Letters, 2008, Vol. 8, No. 2, pp. 446-451.

As shown in FIG. 19, the test case according to an exemplary embodiment is set up identically to the reference case of FIG. 15. However, the glass plate of FIG. 15 is replaced with an anti-glare film 1901 according to an example embodiment. Furthermore, the test case includes a complex layered display 1902, an air gap 1908 between the anti-glare film 1901 and complex layered display 1902, and air 1907 surrounding the anti-glare film 1901. Moreover, ambient light 1903 is directed downwards towards the anti-glare film 1901 with an incident angle 1906, and is reflected as light 1904.

FIG. 20 shows a plot of reflection rate of downward light versus an incident angle for both the reference case in FIG. 15 and the test case in FIG. 19. As shown in FIG. 20, reflection rate of the downward ambient light (i.e., glare) is greatly reduced compared to the simple glass plate in the reference case.

To further quantify the reduction in glare shown in the plot of FIG. 20, the plot is reproduced with semi-logarithm scale as shown in FIG. 21. As clearly shown in FIG. 21, the anti-glare film reduces the glare across the incident angle range by about a factor of 10 when compared with the simple glass plate. This value of 10 is exactly what was predicted for the particular base-to-top area ratio of the truncated tapered structures.

FIG. 22 shows a geometric layout of a test case according to an exemplary embodiment, which will be used to illustrate the anti-glare film preserving a high percentage of transmission rate for upward propagating lights (i.e., light emitting from the complex layered display). The test case shown in FIG. 22 is set up identically to the reference case shown in FIG. 15. However, the glass plate is replaced with an anti-glare film 2201 structured according to an example embodiment. Accordingly, this test case includes a complex layered display 2202, an air gap 2205 between the complex layered display 2202 and the anti-glare film 2201, and air 2204 surrounding the anti-glare film 2201. Furthermore, light 2206 is emitted at an incident angle 2208 towards the ant-glare film 2201, partially deflected from the anti-glare film 2201 as light 2207, and transmitted through the anti-glare film 2201 as light 2203.

FIG. 23 shows a plot of transmission rate of upwards light versus incident angle for the test case of FIG. 22. As shown in FIG. 23, it is clear that at a normal incident angle, upwards light is largely preserved and transmitted through the whole 150 micron thick anti-glare film 2201, at an efficiency higher than 85%. Also, the preservation of the high percentage of transmission rate for the upward light works more efficiently for relatively collimated light along the normal incident angle direction. When the incident angle 2208 is larger than 10 degrees, the emitted light starts to be absorbed by the dark material. Moreover, the upwards light being emitted from a display can be highly collimated naturally. Thus, the anti-glare film's upward transmission characteristics for the emitted light in ±10 degrees is more than adequate.

FIG. 24 shows a plot of a ratio of the transmission rate for the test case and the transmission rate for the reference case versus upward incident angle. As shown in FIG. 24, quantitatively, the anti-glare film in the test case is preserving greater than 80% of the upward emitting light, when compared with the reference case, for an adequate solid angle (i.e., ±4 degrees, which is a numerical aperture of 0.07).

FIG. 25 shows a plot of Signal-to-Noise ratio for the reference case and the test case versus ambient light source angle. If the transmission rate of the light emitting from the display screen is considered the signal, and the ambient light reflecting from the display screen is considered the noise, then an image quality improvement of the display screen can be extrapolated in terms of a Signal-to-Noise ratio (S/N). In extrapolating the improvement in image quality of the display screen, it is assumed that the ambient light source is strong, which makes the original S/N only 1:1. Thus, as shown in the plot of FIG. 25, the S/N improvement obtained when using the ant-glare film is about a factor of 10 for all incident angles of ambient light. This value of 10 is exactly what was predicted for the particular base-to-top area ratio of the truncated tapered structures.

FIG. 26 shows EM field distributions for upward incident light and downward incident light according to an exemplary embodiment. FIG. 26 is intended to show the sharp distinction in transmission and reflection characteristics between the two incident directions of light for the anti-glare film using the EM field profiles. As shown in FIG. 26, EM field distributions (i.e., the square of electrical field amplitude) for the two incidental directions of light (upward and downward) for the anti-glare film of the test case (i.e., a film having a 10:1 base-to-top linear ratio) is plotted side-by-side. As is evident from the EM field profiles, when the incident light is upward (i.e., when light is emitted from the display screen), the emitted light is well guided and concentrated by the truncated tapered structure. At the same time, the emitted light experiences little absorption in the dark material regions. Furthermore, when the light is downward (i.e., ambient light), only a very small portion of the light (in this case about 1/10) enters into the truncated tapered structure, which can then be transmitted by the display screen. More importantly, most of the ambient light hits the dark material at the light emitting face of the anti-glare film, and then is absorbed without any reflection or transmission. This light absorption is clearly shown in the top right side of FIG. 26.

In summary, as realized from the above described simulations, the anti-glare film of the many embodiments can reliably increase a display screen's S/N, by reducing glare created from ambient light. This improvement in S/N is predictable by the base-to-top area ratio of the truncated tapered structures. Further, the S/N improvement factor is not limited to the 10:1 realized in the test case. 100:1 base-to-top area ratio can easily be realized in practice, when the truncated tapered structures are actually sloping in both the y-z plane and x-z plane. Moreover, such an S/N improvement can be combined with any existing anti-glare measures. For example, as described in connection with FIG. 11, if the test case includes a matte surface on the narrowed tops of the truncated tapered structures, instead of a flat surface, then the S/N improvement factor is obtained on top of the matte surface baseline.

In practice, the S/N improvement factor should be even larger than the base-to-top area ratio in reality. This is due to the fact that conventional anti-glare methods usually leave a significant amount of ambient light transmitted into the complex layered structure itself. Thus, a significant portion of the ambient light transmitted into the complex layered structure of the display screen is eventually reflected back into the air and further increases the glare. On the contrary, in the many example embodiments, this un-reflected ambient light does not transmit into the underlying complex layered structure of the display screen, because greater than 99% of the ambient light is absorbed in the dark material.

The invention has been described above with respect to particular illustrative embodiments. It is understood that the invention is not limited to the above-described embodiments and that various changes and modifications may be made by those skilled in the relevant art without departing from the spirit and scope of the invention.

What is claimed is:

1. A film for reducing reflections of ambient light on a display screen while maintaining efficient transmission of light emitted from the display screen, the film having a light receiving face and a light emitting face, wherein the film comprises:
an arrayed plurality of truncated tapered structures projecting from the light receiving face to the light emitting face, wherein each of the plurality of truncated tapered structures has a relatively wider base positioned at the light receiving face, and a relatively narrowed top positioned at the light emitting face, and wherein the plurality of truncated tapered structures define a void region in the vicinity of the light emitting face between adjacent ones of the plurality of truncated tapered structures; and
a dark material applied in the void region.

2. The film according to claim 1, wherein the display screen comprises an array of light emitting pixels, wherein the base of each truncated structure is sized in close correspondence to a size of a pixel of the display screen, wherein each truncated tapered structure is positioned so as to be aligned with a corresponding one of the arrayed pixels of the display screen, and wherein the film has a sufficient thickness to support a ratio of an area of the base to an area of the top of each truncated tapered structure which is larger than 1:1.

3. The film according to claim 2, wherein the film has a thickness of at least 670 microns, which supports a ratio of an area of the base to an area of the top of each truncated tapered structure in a range substantially around 1:1 to 10,000:1.

4. The film according to claim 2, wherein the film has a thickness of at least 500 microns, which supports a ratio of an area of the base to an area of the top of each truncated tapered structure in a range substantially around 1:1 to 20:1.

5. The film according to claim 1, wherein the display screen comprises an array of light emitting pixels, wherein the base of each truncated tapered structure is sized substantially smaller than a size of a pixel of the display screen, and wherein the film has a sufficient thickness to support a ratio of an area of the base to an area of the top of each truncated tapered structure which is larger than 1:1.

6. The film according to claim 5, wherein the film has a thickness of at least 65 microns, which supports a ratio of an area of the base to an area of the top of each truncated tapered structure in a range substantially around 1:1 to 10,000:1.

7. The film according to claim 1, wherein each of the truncated tapered structures consists of a refractive material.

8. The film according to claim 1, wherein each of the truncated tapered structures has an inner core and at least one outer shell surrounding the inner core, and wherein the inner core has a higher refractive index than a refractive index of the outer shell.

9. The film according to claim 1, wherein a surface on each of the narrowed tops of each of the truncated tapered structures is a matte surface.

10. The film according to claim 1, wherein the dark material is applied so as to completely fill the void region.

11. The film according to claim 1, wherein the dark material is applied so as to create a layer on sidewalls of the plurality of truncated tapered structures in the void region.

12. The film according to claim 1, wherein the dark material has a refractive index close to 1.

13. The film according to claim 1, wherein each of the truncated tapered structures has a conical shape.

14. The film according to claim 1, wherein each of the truncated tapered structures has a pyramidal shape.

15. The film according to claim 1, wherein the plurality of truncated tapered structures is arrayed so that the bases of the plurality of truncated tapered structures are close-packed on the light receiving face.

16. The film according to claim 1, wherein the dark material is made up of carbon nanotubes, graphite, or nano-patterned metallic films.

17. A method for manufacturing a film for reducing reflections of ambient light on a display screen while maintaining efficient transmission of light emitted from the display screen, the film having a light receiving face and a light emitting face, wherein the method comprises:
forming an arrayed plurality of truncated tapered structures projecting from the light receiving face to the light emitting face, wherein each of the plurality of truncated tapered structures has a relatively wider base positioned at the light receiving face, and a relatively narrowed top positioned at the light emitting face, and wherein the plurality of truncated tapered structures define a void region in the vicinity of the light emitting face between adjacent ones of the plurality of truncated tapered structures; and
applying a dark material in the void region.

18. The method for manufacturing a film according to claim 17, wherein the display screen comprises an array of light emitting pixels, wherein the base of each truncated structure is sized in close correspondence to a size of a pixel of the display screen, wherein each truncated tapered structure is positioned so as to be aligned with a corresponding one of the arrayed pixels of the display screen, and wherein the film is provided a sufficient thickness to support a ratio of an area of the base to an area of the top of each truncated tapered structure in a range substantially larger than 1:1.

19. The method for manufacturing a film according to claim 18, wherein the film is provided with a thickness of at least 670 microns, which supports a ratio of an area of the base to an area of the top of each truncated tapered structure in a range substantially around 1:1 to 10,000:1.

20. The method for manufacturing a film according to claim 18, wherein the film is provided with a thickness of at least 500 microns, which supports a ratio of an area of the base to an area of the top of each truncated tapered structure in a range substantially around 1:1 to 20:1.

21. The method for manufacturing a film according to claim 17, wherein the display screen comprises an array of light emitting pixels, wherein the base of each truncated tapered structure is sized substantially smaller than a size of a pixel of the display screen, and wherein the film is provided a sufficient thickness to support a ratio of an area of the base to an area of the top of each truncated tapered structure in a range substantially larger than 1:1.

22. The method for manufacturing a film according to claim 21, wherein the film is provided with a thickness of at least 65 microns, which supports a ratio of an area of the base to an area of the top of each truncated tapered structure in a range substantially around 1:1 to 100,000:1.

23. The method for manufacturing a film according to claim 17, wherein each of the truncated tapered structures consists of a refractive material.

24. The method for manufacturing a film according to claim 17, wherein each of the truncated tapered structures is provided with an inner core and at least one outer shell surrounding the inner core, and wherein the inner core has a higher refractive index than a refractive index of the outer shell.

25. The method for manufacturing a film according to claim 17, wherein a matte surface is provided on a surface on each of the narrowed tops of each of the truncated tapered structures.

26. The method for manufacturing a film according to claim 17, wherein the dark material is applied so as to completely fill the void region.

27. The method for manufacturing a film according to claim 17, wherein the dark material is applied so as to create a layer on sidewalls of the plurality of truncated tapered structures in the void region.

28. The method for manufacturing a film according to claim 17, wherein the dark material has a refractive index close to 1.

29. The method for manufacturing a film according to claim 17, wherein each of the truncated tapered structures is provided a conical shape.

30. The method for manufacturing a film according to claim 17, wherein each of the truncated tapered structures is provided a pyramidal shape.

31. The method for manufacturing a film according to claim 17, wherein the plurality of truncated tapered structures is set in an array so that the bases of the plurality of truncated tapered structures are close-packed on the light receiving face.

32. The method for manufacturing a film according to claim 17, wherein the dark material is made up of carbon nanotubes, graphite, or nano-patterned metallic films.
